(19) United States
(12) Patent Application Publication
(10) Pub. No.: US 2003/0137716 A1
(43) Pub. Date: Jul. 24, 2003

(54) Tilting mirror with rapid switching time

(75) Inventors: Robert George Andosca, Nashua, NH (US); Ijaz Hussain Jafri, Londonderry, NH (US); Gregory Arthur Kirkos, Somerville, MA (US); Jonathan Jay Bernstein, Medfield, MA (US)

Correspondence Address: HALE AND DORR, LLP, 60 STATE STREET, BOSTON, MA, 02109

(73) Assignee: Corning Intellisense Corporation

(21) Appl. No.: 10/053,844

(22) Filed: Jan. 22, 2002

(51) Int. Cl. G02B 26/00

(52) U.S. Cl. 359/290

(57) ABSTRACT

A device for rapid optical switching includes a membrane having a reflecting surface on at least a portion of an upper surface of the membrane, first and second spacers at opposing ends of the membrane for securing the membrane to a substrate, whereby the membrane is spaced apart from the substrate, and first and second actuation electrodes positioned on the same side of the membrane and spaced a distance from the membrane so as to form a gap therebetween, whereby actuation of the actuation electrodes applies a force to the membrane to tilt the reflective portion of the membrane at an angle with respect to the substrate.

### FIELD OF THE INVENTION

The invention relates to a method and apparatus for use in switching or directing a light beam. In particular, the invention relates to methods and apparatus for optical switching using tilting mirrors.

### BACKGROUND OF THE INVENTION

Tilt-mirror switch arrays are of interest in systems that use optical beams either for transmission of information or for its control by deflecting or steering incident light.

A common form of tilt-mirror in such arrays includes a member having a mirrored top surface serving as a reflective element and a conductive back surface serving as an electrostatic plate. The substrate is suspended so that its center is supported on a fulcrum about which the substrate can pivot. Pairs of electrodes positioned on opposite sides of the fulcrum are used to create electrostatic forces that pivot the mirror. By applying a control voltage to a selected pair of electrodes, the electrode is attracted by electrostatic forces to the associated half of the substrate, and the mirror can be tilted between the two reflective states. The requirement that they be rigid makes these switches relatively slow.

Another form of micromechanical tilt mirror device includes an electrode-coated membrane supported over a conductive substrate. Electrostatic forces draw the membrane towards the conductive substrate when a voltage is applied between the electrode and the substrate. A mirror is asymmetrically positioned on the membrane and is tilted when the membrane is deformed by electrostatic forces, but does not have both a positive and complementary negative tilt angle.

Other micromirrors rely on a plurality of parallel ribbons suspended above a conductive substrate to mimic the effect of a tilting mirror. The parallel ribbons can be individually controlled to create a phase profile, which reflects light in a controlled fashion. Control of the potential difference to each ribbon and substrate controls the amount of displacement of each ribbon. The device emulates a continuous tilting mirror by forming discrete reflective segments; however, the actuated ribbons have substantial curvature, leading to optical losses. The device is complex, requiring multiple components and a programmable or computer-controlled voltage source in order to operate effectively. The complexity of the device poses significant challenges to reducing optical switching times.

A tilting mirror device is needed that can controllably steer incident light by tilting by a prescribed amount, while avoiding the complexity of other tilt mirror devices.

A tilting mirror device is needed that has a substantially flat tilting region to avoid optical losses caused by mirror curvature.

A tilting mirror device is needed having a mirror area that reflects, or controllably steers, incident light with little attenuation.

In order to operate effectively as an optical switch, the tilt mirror desirably has fast switching speeds, and a design that is readily manufactured using conventional micromachining processing techniques.

These and other limitations of the prior art tilt mirror devices are addressed by the present invention.

### SUMMARY OF THE INVENTION

The mirror device of the present invention includes a membrane having a reflective surface, i.e., a mirror area, suspended over a substrate using spacers. The mirror device further includes electrode pairs positioned below and/or above the membrane. Electrode activation produces an electrostatic force that deforms the membrane and tilts the mirror area out of the plane of the membrane at rest. As a result, the mirrored area is tilted at an angle with respect to the substrate. The tilting mirror can be tilted at both positive and negative angles. Positioning the electrodes at a distance from the reflective surface results in substantially flat reflective surfaces and reduced mirror curvature during membrane deformation.

In one aspect of the invention, a device for rapid optical switching includes a membrane having a reflecting surface on at least a portion of an upper surface of the membrane, first and second spacers at opposing ends of the membrane for securing the membrane to a substrate, whereby the membrane is spaced apart from the substrate, and first and second actuation electrodes positioned on the same side of the membrane and spaced a distance from the membrane so as to form a gap therebetween. Actuation of the actuation electrodes applies a force to the membrane to tilt the reflective portion of the membrane at an angle with respect to the substrate.

In another aspect of the invention, a device for rapid optical switching includes a membrane having a reflecting surface on at least a portion of an upper surface of the membrane, first and second spacers at opposing ends of the membrane for securing the membrane to a substrate and spacing the membrane apart from the substrate, first and second lower actuation electrodes positioned below the membrane, the electrodes spaced a distance from the membrane so as to form a lower gap therebetween, and first and second upper actuation electrodes positioned above the membrane and spaced a distance from the membrane as to form an upper gap therebetween. Upon actuation of the upper and lower electrodes, a force is applied to the membrane to tilt the reflecting surface of the membrane at an angle with respect to the substrate.

In at least some embodiments, the first and second actuation electrodes are positioned below the membrane and adjacent to the first and second spacers. In at least some embodiments, the first and second actuation electrodes are embedded in the substrate and the upper surface of the first and second actuation electrodes is in a plane with the upper surface of the base, or the first and second actuation electrodes are positioned above the membrane.

In at least some embodiments, the upper or the lower gap is in the range of 0.1 to 5 μm. In at least some embodiments, the gap is a vacuum gap.

In at least some embodiments, the membrane has a thickness in the range of 0.1-1.0 μm, or a thickness in the range of 0.3-0.5 μm. In at least some embodiments, the membrane has a tensile stress in the range of 10-1000 MPa, or a tensile stress of about 200 MPa. In at least some embodiments, the membrane includes a multilayer structure including a high stress layer and a conducting layer.

In at least some embodiments, the reflecting surface of the membrane has a reflective layer deposited thereon. The reflective layer can be a metal. In at least some embodiments, the reflective surface of the membrane is a polished surface of the membrane.

In at least some embodiments, the device further includes an insulating layer disposed between the membrane and the actuation electrodes.

The device has a switching speed in the range of about 50 ns to about 500 ns and can be used in a mirror array.

In another aspect of the invention, a method of optical switching using a tilt mirror device is provided. The method includes providing a tilt mirror device having a membrane having a reflecting surface on at least a portion of an upper surface of the membrane, first and second spacers at opposing ends of the membrane for securing the membrane to a substrate, whereby the membrane is spaced apart from the substrate, and first and second actuation electrodes positioned on the same side of the membrane and spaced a distance from the membrane so as to form a gap therebetween, and applying a voltage to the first actuation electrode, whereby the membrane moves relative to the first activation electrode and the membrane bends at an angle with respect to the substrate.

In at least some embodiments, the mirror tilts in either of a positive or a negative tilt angle.

In at least some embodiments, a voltage is applied in the range of 10 to 500V.

In at least some embodiments, the optical switching time is less than 1 ms, or less than 300 ns, or less than 100 ns, or less than 50 ns.

In at least some embodiments, the radius of curvature of the reflective surface is greater than or equal to 10 cm during bending of the membrane, or the reflective surface remains substantially flat during bending of the membrane.

In at least some embodiments, the tilt mirror device further includes third and fourth actuation electrodes positioned on the side of the membrane opposing the first and second actuation electrodes.

In anther aspect of the invention, a method for preparing a tilt mirror device is provided. The method includes the steps of

(a) etching a substrate to form a first recess therein, forming a conductive element in the recess, the conductive element being substantially planar with the substrate surface,

(b) depositing a first layer of sacrificial material and etching the sacrificial layer to obtain a second recess, forming a post comprising a conductive material in the sacrificial layer,

(c) depositing a membrane layer on the post and sacrificial layer surface, and

(d) removing the sacrificial material to obtain a free standing membrane spaced above opposing electrodes on the posts.

In at least some embodiments, the method further includes the steps of

(e) prior to removal of the first sacrificial layer, depositing a second sacrificial layer over the device, and

(f) etching the second sacrificial layer to the substrate surface and depositing a third conductive layer to fill the etched regions,

(g) etching the conductive layer above the membrane, and

(h) removing the sacrificial material to obtain a free standing membrane spaced above opposing lower electrodes and below opposing upper electrodes.

In at least some embodiments, the method includes applying a mirrored surface to the membrane after removal of the sacrificial layers.

As used herein with reference to a specified quantity, “about” refers to a value that is ±10% of the stated value.

### BRIEF DESCRIPTION OF THE DRAWINGS

The invention is further illustrated with reference to the following drawings in which:

FIGS. 1A-1B show in cross section mirror devices according to various embodiments of the invention (dimensions are not drawn to scale),

FIGS. 2A-2B shows in cross section a mirror device according to at least one embodiment of the invention (dimensions are not drawn to scale);

FIG. 3A shows a perspective view of the mirror device according to at least some embodiments of the invention in the resting state and FIG. 3B shows a perspective view of a mirror device in the activated state; the gap is shown much larger than in the actual device;

FIGS. 4A-4C are cross sectional illustrations of the activation of a two-electrode mirror device of the invention providing a positive and negative tilt angle, and FIGS. 4D-4F are cross sectional illustrations of the activation of a four-electrode mirror device of the invention at positive and negative tilt angles;

FIGS. 5A-5H illustrate the processing steps for making at least some embodiments of the invention (reference numerals are omitted in some steps for clarity);

FIGS. 6A-6E illustrate the processing steps for making at least some embodiments of the invention (reference numerals are omitted in some steps for clarity); and

FIG. 7 is a cross sectional illustration of a tilt mirror device of the invention including electrical connections.

### DETAILED DESCRIPTION OF THE INVENTION

Although the embodiments are described and shown with a single mirror, it is apparent that a plurality of mirrors and/or a plurality of membranes may be used. In at least some embodiments, the mirror device includes an array of mirrors. The array can be a one or two-dimensional array.

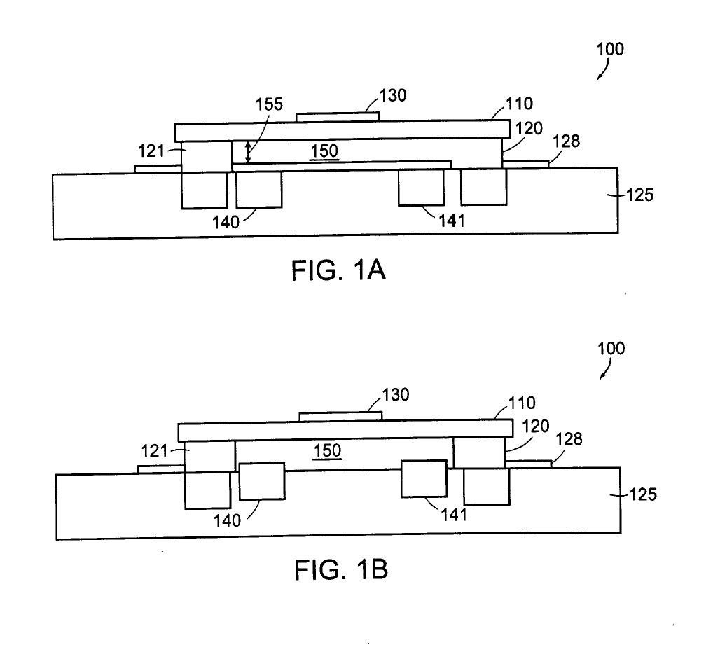

An embodiment of the mirror device of the invention having a single electrode pair on the same side of the membrane is shown in FIG. 1. The mirror device 100 includes a membrane 110 supported at opposing ends by spacers 120, 121 so that the membrane is spaced apart from a substrate 125. In some embodiments, an optional insulating or dielectric layer 128 is disposed between the membrane and the lower electrodes. The dielectric layer can be located on the electrode or membrane surfaces. The device includes a reflective surface 130 located on the upper surface of the membrane; the reflective surface can be a polished surface of the membrane or a separately applied mirrored layer. An electrode pair 140, 141 is located below the membrane. A gap 150 is defined by the spacers and the spanning membrane, which defines, in part, the range of motion of the reflective surface. In at least some embodiments and as shown in FIG. 1, the electrodes are located near or at the spacers and are symmetrically positioned below the membrane. In at least some embodiments and as shown in FIG. 1A, the electrodes are non-overlapping with the reflective surface of the membrane. The electrodes are shown in FIG. 1A embedded in the substrate; in FIG. 1B, an alternative tilt mirror device is shown, in which the lower electrodes are deposited on the surface of the substrate.

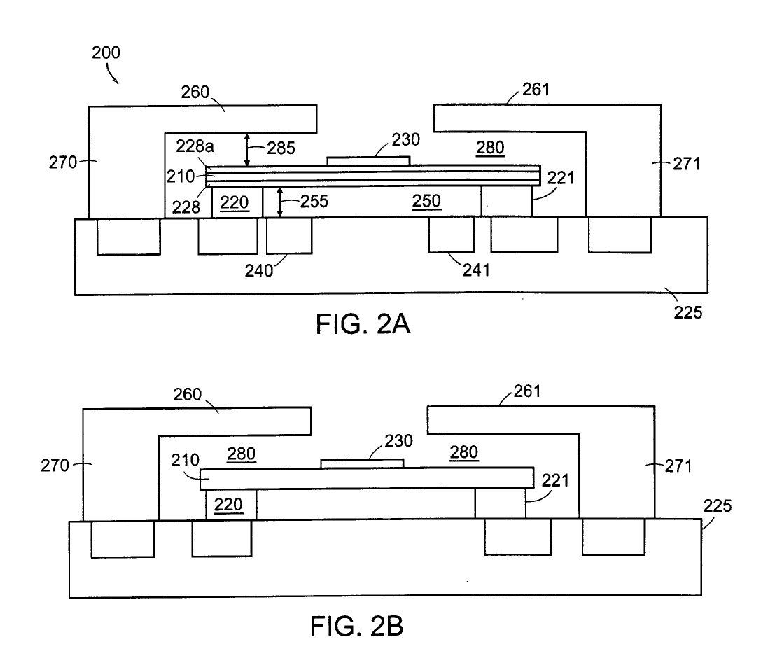

Another embodiment of the mirror device of the invention having two electrode pairs is shown in FIG. 2A. The mirror device 200 includes a membrane 210 supported at opposing ends by spacers 220, 221 so that the membrane is spaced apart from a substrate 225. A reflective surface 230 is located on the upper surface of the membrane 210, which can be a polished surface of the membrane or a separately applied mirrored layer. Optional insulating or dielectric layer(s) 228, 228a can be disposed between the membrane and the upper or lower electrodes to prevent short-circuiting. The layers 228, 228a are shown in FIG. 2A on the upper and lower surfaces of the membrane, resulting in a multilayer membrane structure. The dielectric layers can also be located on the electrode surfaces. A lower electrode pair 240, 241 is located below the membrane. A lower gap 250 defined by the spacers and the spanning membrane. In at least some embodiments and as shown in FIG. 2A, the electrodes are located near or at the spacers and are symmetrically positioned below the membrane. The electrodes are shown in FIG. 2A embedded in the substrate, however, in other embodiments, they are positioned on the flat upper surface of the substrate as illustrated for a two-electrode device in FIG. 1B. An upper electrode pair 260, 261 is positioned above the membrane. The electrodes are spaced apart from the membrane by anchors 270, 271 to form an upper gap 280. The anchors may be integral with the upper electrodes. In at least some embodiments, the electrodes are non-overlapping with the reflective surface of the membrane. Gaps 250 and 280 are defined by the spacers (or anchors) and the spanning membrane, which in turn define, in part, the range of motion of the reflective surface 230. In at least some embodiments, the upper and lower gaps heights are the same. The mirror device functions similarly when a single electrode pair is located above the membrane as is shown in FIG. 2B. A single electrode pair 260, 261 is shown positioned above the membrane 210 supported on posts 270, 271. In this embodiment a single gap 280 above the membrane is involved in mirror tilting.

The membrane is an elongated member that spans an area above the substrate. It is not limited to any particular shape or size, however, in at least some embodiments it is rectangular. The membrane contains at least one conductive material or a non-conductive material coated with a conductive material. For example, the membrane can be a gold-coated dielectric material. In at least some embodiments, the membrane can be made of silicon nitride, polysilicon, silicon, silicon carbide, aluminum alloys, or any other material having suitable tensile stress and durability. The membrane has a thickness and is under a tensile stress sufficient to maintain the membrane essentially rigid, i.e., without sagging between the spacers, yet without requiring excessive electrostatic force for optical switching. In at least some embodiments, the membrane is a low tensile stress material; and in at least some embodiments, the tensile stress is about 10-1000 MPa; and in at least some embodiments, tensile stress is about 200 MPa. In at least some embodiments, the membrane has a thickness (including a deposited mirrored surface, if any) in the range of about 0.1-1 micron (μm), or in at least some embodiments in the range of about 0.3-0.5 microns (μm), or in at least some embodiments, the membrane has a thickness of about 0.3 microns (μm).

In at least some embodiments, the membrane is multilayered. In at least some embodiments, the membrane has a sandwich composition made up of a conducting layer between two dielectric layers. In some embodiments, the sandwich layer is a three-layer composition of silicon nitride/doped polysilicon/silicon nitride. The sandwich configuration prevents short-circuiting in the event that the membrane comes into contact with the electrode during activation. The layers can be of the same or varying thickness. In at least some embodiments, each layer in the multilayer membrane is about 0.1 microns (am) thick.

The reflective surface reflects incident light and can be a mirrored area of the membrane or a mirror applied to the membrane. In at least some embodiments, the mirror area covers a portion of the membrane and is located in a central region, e.g., the mid-point, of the membrane. Alternatively, the mirror area covers substantially the entire upper surface of the membrane. The mirror area may be of gold, silver, aluminum, copper, multi-layer dielectrics or any other suitable reflective material. Exemplary thickness of the reflective layer is about 0.04-0.1 microns (μm) and can be about 0.06-0.08 microns (μm).

Mirror tilt and curvature both are a function of, among other factors, electrode position, membrane length and gap dimension. The ends of the membrane have zero degrees of rotation because their position is fixed by the spacers. In contrast, the center (including the mirror) flexes or bends during operation, and the extent of bending defines the tilt angle. Bending also introduces curvature into the mirror, and curvature is desirably minimized. In order to reduce curvature, the electrodes are located symmetrically about the reflective surface, but do not overlap with the reflective surface. The electrodes are positioned close to, or as near as possible to, the supporting posts. As is discussed in greater detail below, this concentrates membrane bending at a point distant from the mirrored surface so that curvature of the mirror is minimized. In at least some embodiments, the mirror surface exhibits a very large radius of curvature during switching. Radii of curvature greater than 10 cm are contemplated. Generally, the greater the mirror diameter, the greater the gap needed for a given tilt angle. Additionally, the longer the membrane, the lower the slope between opposing ends and the lower the curvature of the mirror. Thus, selection of appropriate parameters for the device elements calls for a balancing of these factors.

The heights of gaps 150, 250 and 280 are shown by arrows 155, 255 and 285, respectively, in FIGS. 1 and 2. In at least some embodiments, the gap is small to provide maximal electrostatic force during operation. In at least some embodiments, the gap height is in the range of about 0.1-5 microns, and in at least some embodiments, the gap height is less than 1 micron, and in at least some embodiments, the gap height is about 0.6 microns. For a constant tilt angle, the gap height is reduced as the mirror diameter decreases. For gap dimensions of about 0.6 μm and membrane lengths of about 100-200 μm, the tilt angle is about +1 degree. In some embodiments, the membrane length is about 150-160 μm.

The electrodes are made up of a conductive material compatible with the processing techniques used in the manufacture of micromechanical devices. In at least some embodiments, the lower electrode pair is deposited on the substrate. In at least some other embodiments, the lower electrode pair is embedded in the substrate. In some embodiments, the upper surfaces of the electrodes are flush with the substrate surface. In at least some embodiments, the electrodes are symmetrically positioned below and/or above the membrane, and are of the same size and shape so that the magnitude and speed of response in both tilt directions (positive and negative) is the same. Electrode sizes and shapes may vary in those embodiments where it is desired to have an asymmetrical response time in different tilt directions. In at least some embodiments having upper and lower electrodes, they are similarly positioned, i.e., overlapping or stacked one over the other with the membrane in-between. When upper electrodes are used, the electrodes are of a size and are positioned such that an aperture remains above the center of the membrane to permit entry of incident light and exit of reflected or deflected light.

Anchors and spacers serve similar purposes of supporting the electrodes or membrane and spacing apart the electrodes and membranes in the tilt mirror device. The anchors, which support the upper electrodes above the plane of the membrane, are typically made up of a conductive material. In at least some embodiments, they are fabricated at the same time as and are integral with the upper electrodes. The spacers are made up of a suitable material that can withstand the mechanical stresses and thermal and chemical treatments of subsequent processing, such as doped polysilicon. In at least some embodiments, the spacers are made up of a conductive material. The spacers may be in electrical contact with the conductive membrane and the electrical contacts of the substrate. In other embodiments, the spacers may be made up of insulating or dielectric material to electrically insulate the two plates of the capacitor, e.g., the conductive element of the membrane and any of the electrodes. The spacer dimensions are selected to stably support the membrane and provide adequate electrical contact to the conductive contacts of the substrate.

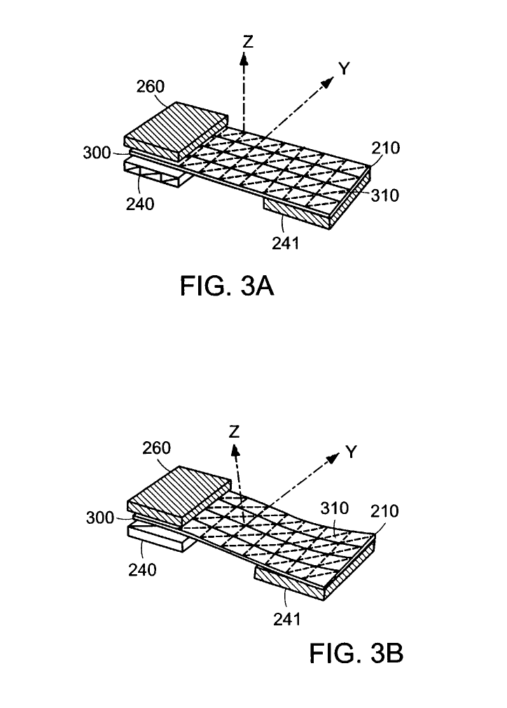

FIG. 3 is a perspective view of the embodiment of the mirror device shown in FIG. 2A, with elements of the device removed for clarity to illustrate operation of the tilt mirror. The views are scaled 10× in the z-direction. FIG. 3A shows the device at rest. The mirror-containing membrane 210 is substantially parallel to the substrate (not shown). Region 300 of the membrane is positioned between electrodes 240 and 260. Region 310 of the membrane is positioned between electrodes 241 and 261 (not shown). The membrane is set at 0 V (grounded). In operation, as illustrated in FIG. 3B, a voltage, e.g., 10-200 V, is applied to one of the lower electrodes and the transverse upper electrode, e.g., electrodes 260 and 241, to attract or pull region 300 of the membrane towards electrode 260 and region 310 of the membrane towards electrode 241, thereby bending or tilting the membrane of the plane of the membrane at rest. The opposite tilt is achieved by activating the other two transverse electrodes, e.g., electrodes 240 and 261. In at least some embodiments, tilt angles are in the range of ±2°, and in at least some embodiments, tilt angles are ±1 degree. In at least some embodiments, in order to reduce viscous forces in operation of the device, the device is operated in a vacuum. A vacuum gap facilitates rapid switching since force is required to move air (or other gas) in and out of the gap below the membrane, which slows the tilting process.

Because the device of the invention employs two electrode pairs, which reinforce each other in the direction and nature of mirror tilt, the switching is very rapid. Switching times of the order of 50 ns to 500 ns are contemplated depending on mechanical dimensions, applied voltages, and membrane stress. In some embodiments, the voltage level may be adjusted after contact of the membrane with the electrode in order to reduce curvature of the mirror surface after actuation. In some embodiments, the voltage is stepped down from the actuation voltage used for activation. In some embodiments, the potential is reduced tenfold.

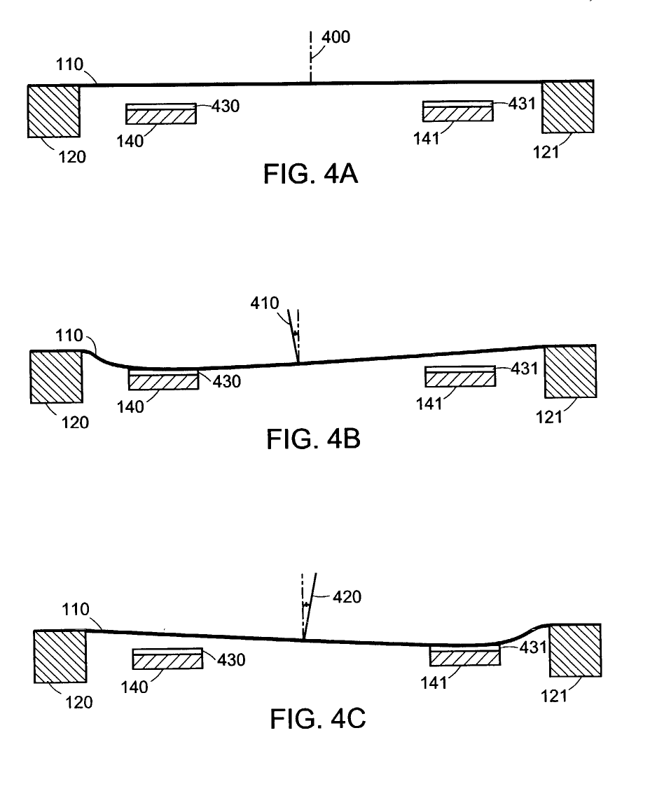

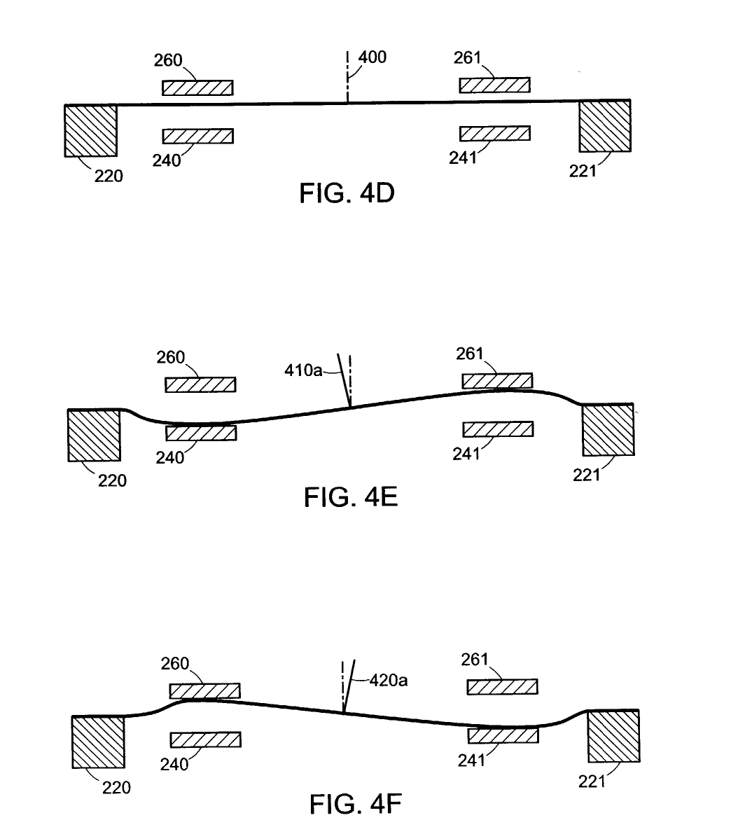

FIGS. 4A-4F illustrate the negative and positive tilting angles in two-electrode (FIGS. 4A-4C) and four-electrode (FIGS. 4D-4F) devices. Device elements are numbered as previously identified. A single electrode pair operates in a manner similar to that described above for the device of FIG. 3, except activation of only one electrode is required to switch or tilt the mirror. At rest, the mirror has a tilt angle of zero degrees 400, as shown in FIG. 4A. When electrode 140 is activated by applying a voltage, the membrane 110 is pulled towards the electrode and the resultant deformation tilts the mirror at tilt angle 410, as shown in FIG. 4B. The mirror may be tilted in the opposite direction by activation of electrode 141 and tilt angle 420 is obtained (FIG. 4C). Note that this embodiment uses an optional dielectric layer 430, 431 on the electrode 140, 141.

A tilt mirror device having electrodes above and below the membrane and reflective surface is shown in FIGS. 4D-4F. The operation of the device is similar in principle to the device having electrodes below the membrane; activation of opposing transverse electrodes bend the membrane out of plane resulting in either a negative tilt angle (FIG. 4E) or a positive tile angle (FIG. 4F) with very little mirror curvature. The positioning of the electrodes symmetrically about the reflective surface minimizes the membrane curvature, so that a flat mirror surface is maintained.

Because the electrostatic attraction is inversely proportional to the square of the distance between the conductors, and also because the distances involved are quite small, very strong attractive forces and accelerations can be achieved. These are counterbalanced by a strong tensile restoring force in the membrane. In at least some embodiments, the membrane has a tensile stress of greater than or equal to 200 MPa. The net result is a robust, highly uniform and repeatable mechanical system. The combination of low membrane mass, small displacement distances and large attractive and restoring forces produces extremely fast switching speeds. Switching speeds between 50 ns and 500 ns are contemplated.

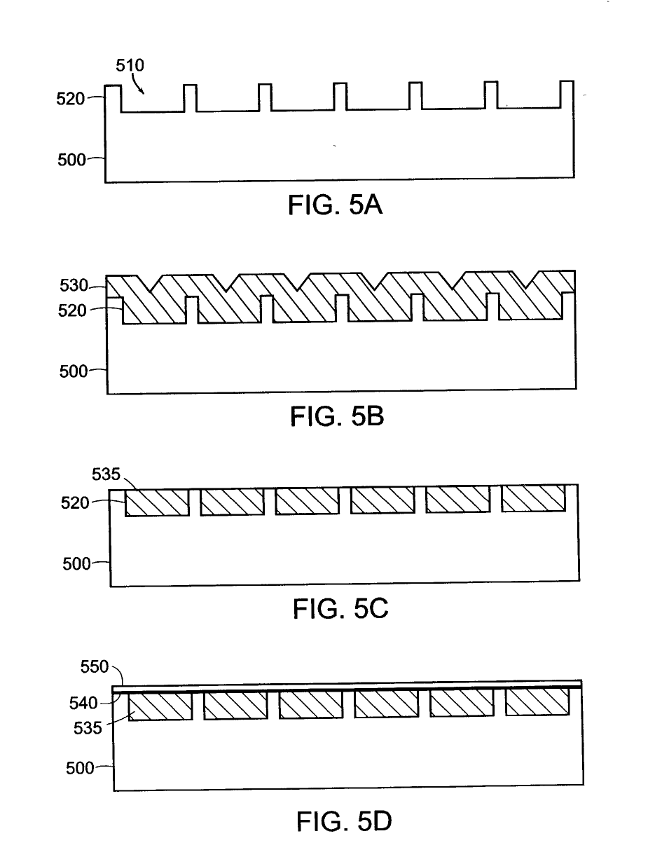

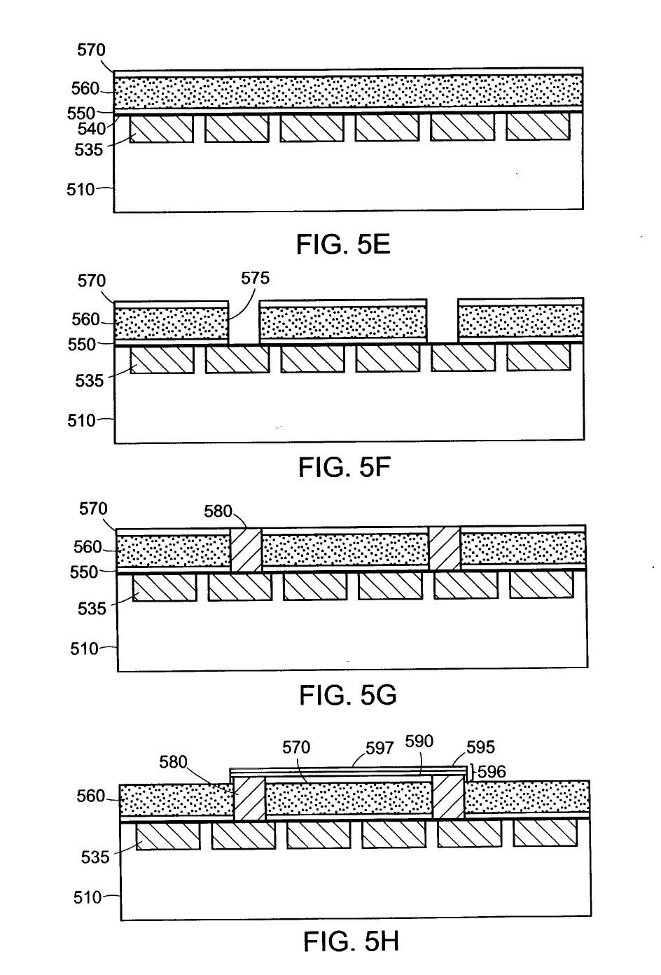

A typical process for forming a mirror device is described with reference to FIGS. 5A-5H. Fabrication is accomplished using techniques that are well established for the preparation of micromechanical devices. The process includes bulk and surface micromachining techniques.

The substrate 500 is made up of a thermally stable material, since manufacturing involves high temperature processing. In at least some embodiments, a single crystal wafer, such as (100) silicon is used. This has the advantage of surface uniformity without post-processing.

The mirror devices are formed typically by first reactive ion etching (RIE) a wafer, preferably (100) silicon, to form recessed areas 510 as a pattern for the lower electrodes. The etched substrate is subsequently oxidized in a thermal oxide process to form a thin (0.8 micron) oxide layer 520 on the substrate (FIG. 5A). Following this process, the recessed areas 510 are filled with a low-pressure chemical vapor deposition (LPCVD) polysilicon layer 530 (FIG. 5B), planarized using chemical mechanical planarization (CMP) and doped to obtain conductive polysilicon regions 535 (FIG. 5C). For example, ion implant and implant driving techniques may be used to obtain conducting polysilicon. A thermal oxide layer 540 (e.g., 50 nm) is grown on the polysilicon to provide substrate-embedded electrical routing lines and an LPCVD silicon nitride layer 550 (e.g., 100 nm) is deposited on top for passivation (FIG. 5D). Contact vias are patterned and etched into the nitride and oxide passivation layer so that later electrical contacts can be made (not shown).

A sacrificial oxide layer of a low temperature oxide (LTO) 560 is deposited on the top surface at a thickness that defines the gap between the electrode surface and the membrane, e.g., 600 nm, followed by a deposition of a high tensile stress LPCVD layer 570 of silicon nitride (e.g., 100 nm) as the bottom layer of the membrane (FIG. 5E). The support posts/membrane electrical connections are then fabricated by patterning and etching layers 550, 560 and 570 to form trenches 575 (FIG. 5F), followed by deposition of an LPCVD layer of polysilicon, which is then, planarized and implanted to provide electrically conducting support posts 580 (FIG. 5G). Subsequently, a layer of LPCVD polysilicon 590 is deposited (e.g., 10 nm) and implanted to serve as the conductor in the membrane. This layer is capped off by another layer of high tensile strength LPCVD silicon nitride as the top layer 595 of the membrane. This structure is then patterned and etched in the form of the membrane. Thus, a three-layer membrane 596 of high tensile stress silicon nitride/conductive polysilicon/high tensile stress silicon nitride is obtained (FIG. 5H). The sacrificial LTO layer 560 is then removed by buffered oxide etch to release the membrane and form the gap between the buried electrical contacts in the substrate and the membrane.

The structure in FIG. 5H is a tilt mirror device having a single electrode pair below the membrane surface. In order to finish the device, a mirrored surface 597 can be attained by deposition of a reflective metal layer. Alternatively, the mirrored surface 597 can be comprised of a multi-layer dielectric stack. The dielectric stack includes alternating high and low index of refraction layers, wherein each layer has an optical thickness of λ/4. The mirroring step can be accomplished before or after removal of the sacrificial layer 560. Thus, a 4 nm Cr/50 nm Au layer is deposited using standard metallization and lithography techniques, followed by buffered oxide etch (BOE) to release the membrane and critical point drying to obtain the final structure (discussed in greater detail below). Alternatively, the top surface of the membrane is fine finish polished to provide a mirrored surface.

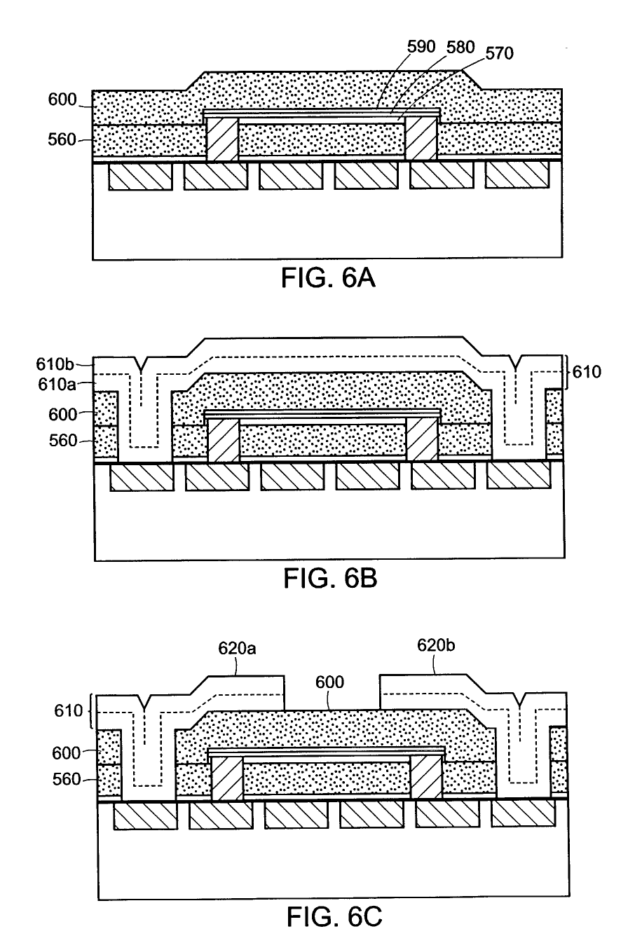

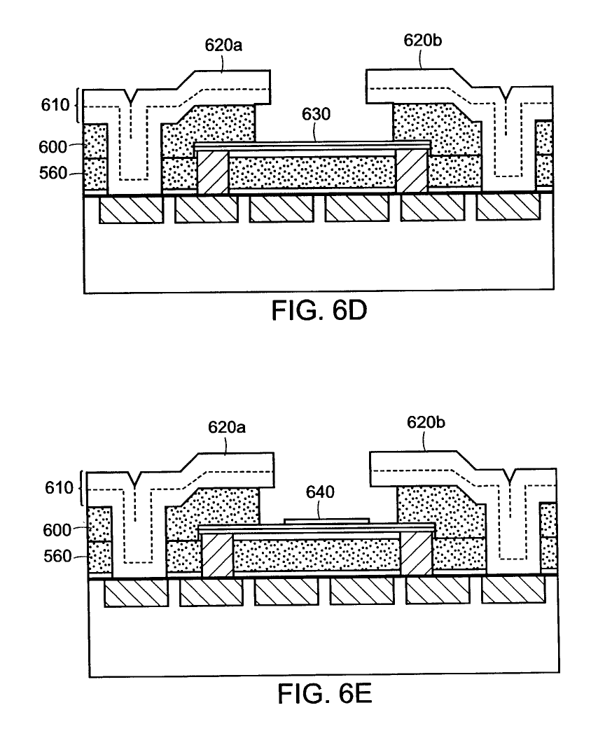

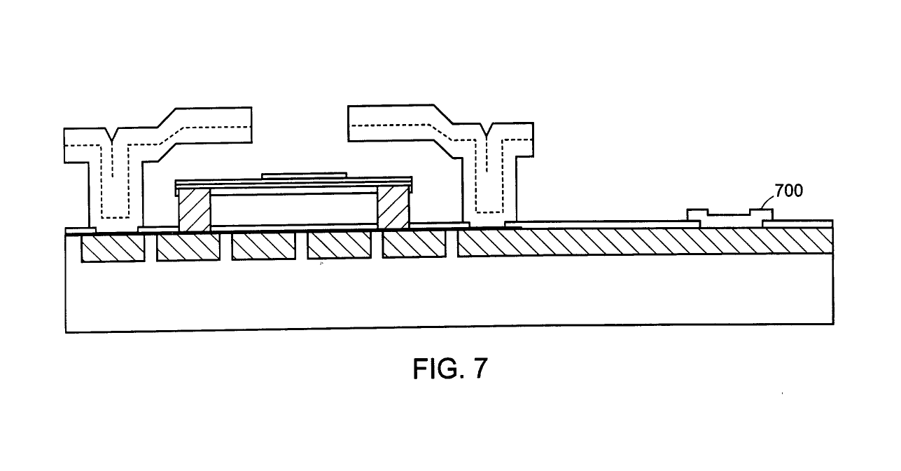

If a two electrode pair device is to be fabricated, additional steps are necessary, which are shown in FIGS. 6A-6E. Prior to removal of the sacrificial layer 560, a second sacrificial oxide (LTO) layer 600 is deposited on the upper surface of the device (FIG. 6A). The layer 600 defines the spacing between the membrane and the upper electrodes. The first and second sacrificial layers 560 and 600 are patterned and etched down to the buried electrical contacts in the substrate (FIG. 6B). A thick layer 610, e.g., 2-3 microns of LPCVD polysilicon is deposited in two steps to form anchors and the upper electrodes. Due to the layer thicknesses, the layer is deposited as two layers 610a and 610b, each deposition step followed by an ion implantation step and a final implant drive to render the layers conductive. The upper electrodes 620a, 620b are formed by patterning and etching to expose the sacrificial oxide layer 600 underneath (FIG. 6C). A timed buffered oxide etch (BOE) is performed which does not remove the entire sacrificial layer, but which exposes the upper surface of the membrane 630 and the top surface of the silicon nitride coated buried electrical lines (enough time to reopen contact vias (not shown)) (FIG. 6D). Next two deposition/photo liftoff steps are completed. The first step is a deposition of an aluminum layer (0.5 microns) for the contact pads that contacts the buried electrical routing lines through the contact vias (not shown). The second step is the mirror deposition step which is a 4 nm Cr/50 nm Au metallization that serves as the reflective mirror 640 on top of the membrane (FIG. 6E). Alternatively, the reflective mirror 640 can be comprised of a multi-layer dielectric stack. The dielectric stack includes alternating high and low index of refraction layers, wherein each layer has an optical thickness of λ/4. This is followed by BOE membrane release by removal of all sacrificial oxide and critical point drying. FIG. 7 shows a two electrode pair mirror device including aluminum contact pads 700 after release of the membrane and upper electrodes. All elements are identified as previously numbered.

Typically the mirror and electrode coatings are thin layers of gold to provide both the desired physical properties and to be resistant to the etch. As a possible modification, the deposition and patterning of the mirrors and electrodes may occur after the sacrificial wet etch, if there is potential incompatibility between the metals to be used for the coatings and the wet etch.

While the present invention has been described with reference to several embodiments thereof, those skilled in the art will recognize various changes that may be made without departing from the spirit and scope of the claimed invention. Accordingly, the invention is not limited to what is shown in the drawings and described in the specification, but only as indicated in the appended claims.

What is claimed is:

1. A device for rapid optical switching, comprising:
a membrane having a reflecting surface on at least a portion of an upper surface of the membrane;
first and second spacers at opposing ends of the membrane for securing the membrane to a substrate, whereby the membrane is spaced apart from the substrate;
first and second actuation electrodes positioned on the same side of the membrane and spaced a distance from the membrane so as to form a gap therebetween, whereby actuation of the actuation electrodes applies a force to the membrane to tilt the reflective portion of the membrane at an angle with respect to the substrate.

2. The device of claim 1, wherein the first and second actuation electrodes are positioned below the membrane and adjacent to the first and second spacers.

3. The device of claim 1, wherein the first and second actuation electrodes are embedded in the substrate and the upper surface of the first and second actuation electrodes is in a plane with the upper surface of the base.

4. The device of claim 1, wherein the first and second actuation electrodes comprise deposited layers on the substrate.

5. The device of claim 1, wherein said first and second actuation electrodes are positioned above the membrane.

6. The device of claim 1, wherein the gap is in the range of 0.1 to 5 μm.

7. The device of claim 1, wherein the gap comprises a vacuum.

8. The device of claim 1, the reflecting surface of the membrane comprises a reflective layer deposited thereon.

9. The device of claim 8, wherein the reflective layer comprises metal.

10. The device of claim 1, wherein the reflective surface of the membrane comprises a polished surface of the membrane.

11. The device of claim 1, wherein the membrane has a thickness in the range of 0.1-1.0 μm.

12. The device of claim 1, wherein the membrane has a thickness in the range of 0.3-0.5 μm.

13. The device of claim 1, wherein the membrane has a tensile stress in the range of 10-1000 MPa.

14. The device of claim 1, wherein the membrane has a tensile stress of about 200 MPa.

15. The device of claim 1, wherein the membrane comprises a multilayer structure including a high stress layer and a conducting layer.

16. The device of claim 15, wherein the high stress layer comprises high stress silicon nitride, polysilicon, silicon, oxynitride, or silicon carbide.

17. The device of claim 1, further comprising:
an insulating layer disposed between the membrane and the first and second actuation electrodes.

18. The device of claim 1, wherein the device has a switching speed in the range of about 50 ns to about 500 ns.

19. The device of claim 1, wherein the mirror is a mirror array.

20. A device for rapid optical switching, comprising:
a membrane having a reflecting surface on at least a portion of an upper surface of the membrane;
first and second spacers at opposing ends of the membrane for securing the membrane to a substrate and spacing the membrane apart from the substrate;
first and second lower actuation electrodes positioned below the membrane, the electrodes spaced a distance from the membrane so as to form a lower gap therebetween;
first and second upper actuation electrodes positioned above the membrane and spaced a distance from the membrane as to form an upper gap therebetween,
whereby upon actuation of the upper and lower electrodes, a force is applied to the membrane to tilt the reflecting surface of the membrane at an angle with respect to the substrate.

21. The device of claim 20, wherein the lower gap is in the range of 0.1 to 5 μm.

22. The device of claim 20 or 21, wherein the upper gap is in the range of 0.1 to 5 μm.

23. The device of claim 20, wherein the upper and lower gap comprises a vacuum gap.

24. The device of claim 20, wherein the membrane comprises a metal.

25. The device of claim 20, wherein the reflecting surface comprises a polished surface of the membrane.

26. The device of claim 20, wherein the reflecting surface of the membrane comprises a reflective layer deposited on the membrane.

27. The device of claim 26, wherein the reflective layer comprises a multi-layer dielectric stack.

28. The device of claim 26, wherein the reflective layer comprises metal.

29. The device of claim 20, wherein the membrane has a thickness in the range of 0.1-1.0 μm.

30. The device of claim 20, wherein the membrane has a thickness in the range of 0.3-0.5 μm.

31. The device of claim 20, wherein the membrane has a tensile stress in the range of 10-1000 MPa.

32. The device of claim 20, wherein the membrane has a tensile stress of about 200 MPa.

33. The device of claim 20, wherein the membrane comprises a multilayer structure including a high stress layer and a conducting layer.

34. The device of claim 33, wherein the high stress layer comprises high stress silicon nitride, silicon carbide, silicon oxynitride, or polysilicon.

35. The device of claim 20, further comprising:
an insulating layer disposed between the membrane and the first and second actuation electrodes.

36. The device of claim 20, wherein the device has a switching speed in the range of about 50 ns to about 500 ns.

37. The device of claim 20, wherein the mirror is a mirror array.

38. A method of optical switching using a tilt mirror device, comprising:
providing a tilt mirror device comprising:
a membrane having a reflecting surface on at least a portion of an upper surface of the membrane;
first and second spacers at opposing ends of the membrane for securing the membrane to a substrate, whereby the membrane is spaced apart from the substrate;
first and second actuation electrodes positioned on the same side of the membrane and spaced a distance from the membrane so as to form a gap therebetween,
applying a voltage to the first actuation electrode, whereby the membrane moves relative to the first activation electrode and the membrane bends at an angle with respect to the substrate.

39. The method of claim 38, wherein the mirror tilts in either of a positive or a negative tilt angle.

40. The method of claim 38, wherein the applied voltage is in the range of 10 to 500V.

41. The method of claim 38, wherein the optical switching time is less than 1 ms.

42. The method of claim 38, wherein the optical switching time is less than 300 ns.

43. The method of claim 38, wherein the optical switching time is less than 100 ns.

44. The method of claim 38, wherein the optical switching time is less than 50 ns.

45. The method of claim 38, wherein the radius of curvature of the reflective surface is greater than or equal to 10 cm during bending of the membrane.

46. The method of claim 38, where the reflective surface remains substantially flat during bending of the membrane.

47. The method of claim 38, wherein the tilt mirror device further comprises third and fourth actuation electrodes positioned on the side of the membrane opposing the first and second actuation electrodes.

48. A method for preparing a tilt mirror device, comprising:
etching a substrate to form a first recess therein;
forming a conductive element in the recess, the conductive element being substantially planar with the substrate surface;
depositing a first layer of sacrificial material and etching the sacrificial layer to obtain a second recess;
forming a post comprising a conductive material in the sacrificial layer;
depositing a membrane layer on the post and sacrificial layer surface; and
removing the sacrificial material to obtain a free standing membrane spaced above opposing electrodes on the posts.

49. The method of claim 48, further comprising:
prior to removal of the first sacrificial layer, depositing a second sacrificial layer over the device;
etching the second sacrificial layer to the substrate surface and depositing a third conductive layer to fill the etched regions;
etching the conductive layer above the membrane; and
removing the sacrificial material to obtain a free standing membrane spaced above opposing lower electrodes and below opposing upper electrodes.

50. The method of claim 49, further comprising:
applying a mirrored surface to the membrane after partial or complete removal of the sacrificial layers.
